(19) United States
(12) Patent Application Publication
(10) Pub. No.: US 2018/0318735 A1
(43) Pub. Date: Nov. 8, 2018

(54) MULTI-LAYERED WATER PURIFYING DEVICE FOR THE PROTECTION OF THE WASHING MACHINE AND DISH WASHER

(71) Applicant: ABI MICRO FILTERS, Chennai (IN)

(72) Inventors: Savitha Kota, Chennai-40 (IN); Nageshwar Kota, Chennai-40 (IN)

(21) Appl. No.: 15/773,062

(22) PCT Filed: Nov. 4, 2016
(86) PCT No.: PCT/IB2016/001701

§ 371 Date: May 2, 2018

(30) Foreign Application Priority Data
Nov. 5, 2015 (IN) 5982/CHE/2015

(51) Int. Cl. B01D 29/58; B01D 29/05; B01D 29/66; C02F 1/00; B01F 1/00; A47L 15/42; A47L 15/44; D06F 39/10; D06F 39/02

(52) U.S. Cl. CPC B01D 29/58; B01D 29/05; B01D 29/66; C02F 1/001; B01F 1/0016; A47L 15/4202; B01F 2215/008; A47L 15/44; D06F 39/10; D06F 39/02; C02F 2307/12; C02F 2303/16; B01F 2001/0088; A47L 15/4208

(57) ABSTRACT

A water filter apparatus for use in filtering particles out of a water supply is provided. The apparatus comprises a multiple layered mesh type filter housing having a top proximal end and a bottom distal end, wherein the top proximal end comprising dual projected passageways adapted to be connected with an upstream water supply and for the addition of the soap powder, solution and detergent to the upstream water prior to the filtration process, The cup or cone shaped funnel is attached, either at the side or at the top of the said top proximal end of the purifier as shown in figs. The funnel act as the passage for detergent or soap powder, mixed inside the purifier before entering the filter. The device enables the mixing of the soap powder or detergent with the upstream water prior to the process of filtration executed by the mesh arrangement. The water and soap powder combination provided in the form a powder solution is in-let into the mesh arrangement for filtration which avoids the formation of scaling in the washing machine and the formation of the white patches in the washed clothes. The filtering device comprises at least six filtering meshes of varied micron sizes sandwiched between the top proximal end and the bottom distal end. The meshes are arranged in such a fashion as to comprise the larger micron sized mesh closer to the top proximal end with correspondingly decreasing micron sized meshes to the bottom distal end. The more important aspect of the invention being that the water purifier is capable of cleaning the filter and cartridge through backwash or reverse wash process by connecting the said purifier arrangement in the upside down position to the said tap water inlet.

### FIELD OF THE INVENTION

The present invention relates generally to water filters, and more particularly, to multiple-layered water filter device comprising a cone or cup shaped funnel attached at the top or side of the water purifier acting as a passage for the detergent and for use in filtering particles out of an upstream water supply source prior to the in-let into the washing machine. The present invention prevents the formation of scaling in the washing machine and the formation of white patches in the washed clothes by filtering out the undissolved detergents, soap powders from the in-let water mixed soap powder solution of the device.

### BACKGROUND AND PRIOR ART OF THE INVENTION

In the prior art, water filters to physically remove solid matter or suspended impurities, such as sand or other sediment, dirt and impurities both visible and invisible are well-known. Most filtration systems deal with whole house filtration, some appliance filtration, or filtration of drinking water. Even with a whole house filter system, sediment typically still gets through the water system and can clog downstream devices, such as clothes washing machines and dish washers that utilize the water supply.

One of the main problems with sediment occurs in the water inlet valve on a clothes washing machine. Typically, the only filtration on a washing machine is an inlet valve screen which is a permanent filter screen designed to collect sediment from a water supply flow and which is located behind the washing machine on the cold water inlet valve (where a cold water supply hose connects). When this screen gets sediment buildup, the cold water flow typically decreases or can stop altogether. This water restriction can increase the time required to complete a wash cycle or can distort the water temperature in the wash cycle. In order to clean this screen, a user typically must cut off the water supply, pull the washing machine away from the wall, and disconnect the cold water supply hose from the water inlet valve. The screen is then removed and cleaned, the screen is replaced, the hose is reconnected, and the washing machine is pushed back into place and the water turned back on. This is a very time consuming and aggravating chore, which in some situations (such as in homes on well water) must be performed as often as monthly.

Another problem with the removal of the washing machine inlet valve screen is that occasionally the screen is damaged during the removal and/or cleaning process. If damaged, the screen may allow sediment through wherein the sediment may get caught in the inlet valve solenoid, which controls the water supply line that is connected to the washing machine. A grain of sand or other sediment caught between a water valve and its solenoid valve seat in a washing machine is sufficient to prevent the water valve from fully seating, with consequential water leakage and possible washing machine overflow.

An analysis of the prior art patent documents provide numerous applications providing a solution to the above problem. U.S. Patent Application Publication No. 2005/0072725 to Swanson is directed to an inline filter adapted for use along a water supply line, including flexible inlet and outlet connecting tubes and an intermediate filter body joined together by a pair of dual-diameter connecting fittings defining a flow passageway there through. U.S. Pat. No. 6,494,325 to Mizrahi discloses a toilet water-line filter in which a mesh straining element is positioned within a housing which may be threaded by means of external wings intermediate the toilet fill valve and a flexible supply line. U.S. Pat. No. 5,223,136 to Gilbert and U.S. Pat. No. 5,992,643 to Scrogham et al. discloses filters which are mounted within rigid elongate pipes that are attached in line with supply lines. The uses of flexible hoses with filters are shown in U.S. Pat. No. 5,078,862 to Justice wherein a lint trap filter is employed in a washing machine drain hose and U.S. Pat. No. 3,685,657 to Hunter et al. discloses wherein the fabric covering acts as a strainer.

U.S. Pat. No. 4,863,591 to Dionne is directed to an inline filter, mounted and disposed in line with respect to an incoming water supply line for a washing machine or lawn sprinkler, to filter out sand, dirt, particles and other debris from water flowing through the supply line. U.S. Pat. No. 4,609,459 to Hendrix describes a filter apparatus, having a hollow, T-shaped, rigid body, which may be connected along a water line and has filter elements which may be interchanged or replaced. U.S. Pat. No. 4,604,202 to Movshovits is directed to a mesh-type filter which may be threaded onto the end of a faucet or nozzle.

While the prior art references described above have attempted to solve the aforementioned problems associated with the presence of sediment in water supply systems, they typically have not allowed for graduated removal of sediment of various sizes within a single unit through a multiple layered mesh filtering unit of varied micron size and a provision provided in the filtering device for the supply of the soap powder or solution and detergent prior to the filtering process.

### SUMMARY OF THE INVENTION

A water filter apparatus for use in filtering particles out of a water supply is provided. The apparatus comprises a multiple layered mesh type filter housing having a top proximal end and a bottom distal end, wherein the top proximal end comprising dual projected passageways adapted to be connected with an upstream water supply and for the addition of the soap powder, solution and detergent to the upstream water prior to the filtration process. The cup or cone shaped funnel is attached, either at the side or at the top of the said top proximal end of the purifier as shown in figs. The funnel act as the passage for detergent or soap powder, mixed inside the purifier before entering the filter. The device enables the mixing of the soap powder or detergent with the upstream water prior to the process of filtration executed by the mesh arrangement. The water and soap powder combination provided in the form a powder solution is in-let into the mesh arrangement for filtration which avoids the formation of scaling in the washing machine and the formation of the white patches in the washed clothes.

The filtering device comprises at least six filtering meshes of varied micron sizes sandwiched between the top proximal end and the bottom distal end. The meshes are arranged in such a fashion as to comprise the larger micron sized mesh closer to the top proximal end with correspondingly decreasing micron sized meshes to the bottom distal end. The more important aspect of the invention being that the water purifier is capable of cleaning the filter and cartridge through backwash or reverse wash process by connecting the said purifier arrangement in the upside down position to the said tap water inlet.

### OBJECT OF THE INVENTION

It is an object of the present invention to provide a tap water purifier with in-built filter arrangement that is capable of removing impurities from the upstream water of the size of 10 to 5 micron prior to the in-let into the washing machine and dish washers.

It is also an object of the present invention to provide at least six filtering meshes with varied micron sizes sandwiched between the top proximal end and the bottom distal end for the gradual filtration of the sediments, dirt, visible and invisible impurities from the upstream water.

It is another object of the present invention to provide at least two projected passageways of different dimensions and shape in the top proximal surface adjacent to one another enabling the easy connection with the tap water source and for the addition of the soap powder, solution and detergents.

It is one another object of the present invention to provide a removable cap arrangement for temporarily closing the said projected passageways enabling the addition of the soap powder, solution and detergents during unused situations.

It is still another object of the present invention to provide multiple stalks of considerable height placed diagonally for separating each of the filtering meshes and for enabling the ease of flow of the water after subsequent filtration process to the further stages of filtration.

It is yet another object of the present invention to provide an air pressure sectional pump arrangement acting independently for the removal of the clogged impurities from the said device.

It is one of the other objects of the present invention to provide a filtering device that mixes the impure water from the upstream with the manually added soap powder or detergent and forms a soap solution prior to the entry into the filtering mesh arrangement wherein said soap solution is filtered repeatedly by the filtering device.

It is a further object of the present invention to provide a filtering device that is capable of filtering the in-let soap powdered coarse solution and provide a completely mixed soap solution to be in-let into the washing machine for the prevention of the scaling in the washing machine and for the prevention of the white patches formed in the washed clothes due to the unsolved soap powder.

It is one of a final object of the present invention to provide meshes of micron size varying from 841 to 400, 177, 149, 125 and 105 sandwiched sequentially from the top proximal end to the bottom distal end separated by the diagonal stalks.

It is a final object of the present invention to provide a filtering device with in-built capacity to clean the filter and sandwiched meshes by positioning the system to the back wash or reverse wash mode by connecting its top and bottom sides reversed to the inlet of the tap water for the removal of sediments, dirt and waste accumulated in the filter cum mesh assembly.

### STATEMENT OF THE INVENTION

1) A multiple level water pre-filter device removably attached to the in-let of the washing machine and dish washer comprises
   (1) A proximal top surface comprising at least two protruding projections for the in-let of the water from the upstream and the washing powder and solutions.
   (2) A distal bottom surface comprising at least one protruding projection for the out-let of the multi-level filtered water mixed with the said powder and soap solutions.
   (3) Multi-layered filtering material sandwiched between the said top proximal surface and the bottom distal surface.
   (4) A narrow separator stalks interlaced between each of the said multi-layered filtering material for providing a space for the flow of filtered water between each of the said material.
2) A method of purifying and filtering the sediments, dirt, visible and invisible impurities from the upstream water prior to the in-let of the washing machine and dish washer comprises the steps of
   i) In-letting the impure water from the upstream containing the sediments, dirt, visible and in visible impurities through the said cylindrical projection provided in the top proximal surface of the said filtering apparatus prior to the in-let into the washing machine and dish washer.
   ii) Manually in-letting the detergent through the said conical projection provided adjacent to the said cylindrical projection in the said top proximal surface for mixing with the water from the upstream prior to the entering of the underlying mesh in the filtering device.
   iii) Providing a space prior to the multi-layer filtering mesh for the mixing of the said upstream water and the said detergent, soap powder and solution.
   iv) Allowing the flow of the detergent mixed unfiltered water with impurities through the said multi-layered mesh filtering means positioned below the said top proximal surface separated by the vertical stalk.
   v) Repeated filtering the detergent mixed water by the said at least six levels of mesh filtering means.
   vi) Out-letting the purified water void of sediments, dirt and visible, invisible impurities through the out-let port for domestic usage by the washing machine and dish washer.
3) A method for reverse or back washing the said device for the removal of the trapped sediments, dirt and visible, invisible impurities from the said device comprises the steps of
   i. Reverse washing the said device wherein the in-let and out-let ports are reversed for the removal of the filtered impurities.
   ii. Connecting the said water purifier assembly to the upstream water in a reverse position as the bottom distal side in the upwards position and top proximal side in the downwards position.
   iii. Free flowing the trapped impurities under the pressure of the water used for cleaning the device.
   iv. Injecting fresh water through the out-let port for removing the impurities out of the device leaving the said device free of the trapped impurities.
   v. Restoring the said device to the original position for reinstating the top proximal surface and bottom distal surface to its original position for executing the normal performance of cleaning.

### BRIEF DESCRIPTION OF THE DRAWINGS

FIG. 1 illustrates the front view of the washing machine protector along with the respective dimensions.

FIG. 2 illustrates the front view of the accessories including the vacuum pressure pump, hose pipe, couplings provided along with the said device for the ease of connection with the machine.

FIG. 3 illustrates the device operating in the reverse/backwash process.

### DETAILED DESCRIPTION OF THE INVENTION

Scaling in washing machine is caused by detergent or soap powder not fully dissolving during the washing cycle. This can happen for several reasons including hard water problems, overloading the machine and using too much of undissolved detergent. The best way to combat scale build up is to prevent it from happening in the first place and purchasing a water-softening system to remove hard minerals from the water supply, but it is an expensive remedy. Also the clothes washed from certain machines contain white patches appearing irregularly on the washed clothes leading to discomfort of the users. The present invention overcomes the above said problems through the multiple layered mesh filtering device with external passageways for the upstream water and the soap powder/detergents at the top proximal ends. These passageways provide a complete admixture of the soap powder with the upstream impure water and the said coarse soap solution is in-let into the filtering device for performing the filtering process. The out-let of the filtering device provides a completely mixed fine particle sized soap solution to be used for the washing of the clothes in the washing machine.

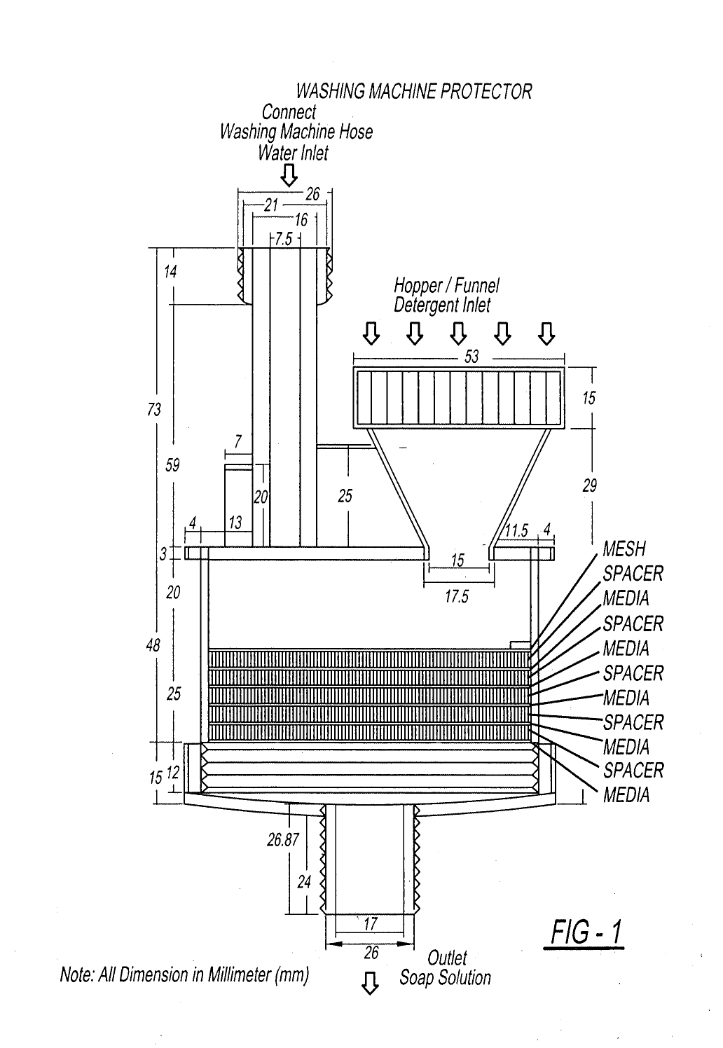

Referring to the drawings, particularly FIG. 1, a water filter apparatus, for filtering particles (e.g., sediment, dirt, visible and invisible impurities) out of a water supply source will now be described. Water filter is shown to include a filter housing, with at least two projections, one being cylindrical for in-letting the impure water from the upstream water source and the other conical projection passageway for in-letting the soap powder, solution and detergent manually provided at the top proximal end and a housing cap removably sealed for the said conical projection passageway. Filter housing and housing cap can be constructed of any suitable material, such as injection-molded polyvinyl chloride (PVC) plastic or the like, wherein the material constructs can be substantially transparent or substantially opaque.

The multiple level water pre-filter device as illustrated in FIG. 1, removably attached to the in-let of the washing machine and dish washer comprises a proximal top surface comprising at least two protruding projections for the in-let of the water from the upstream and the washing powder and solutions, a distal bottom surface comprising at least one protruding projection for the out-let of the multi-level filtered water mixed with the said powder and soap solutions, multi-layered filtering material sandwiched between the said top proximal surface and the bottom distal surface and a plurality of narrow separator stalks interlaced between each of the said multi-layered filtering material for providing a space for the flow of filtered water between each of the said material.

These two passageways designed on the top proximal surface are adjacent to one another but are not limited to the top loading but also fixed to the side walls of the top proximal surface enabling the ease of loading the upstream water and the detergent solution into the filtering chamber. The conical passageway provided on either the top surface or on the side walls of the top proximal surface is provided with a removably closed cap or lid for providing protection to the machine from the entry of foreign materials into the said washing machine at times of non-usage.

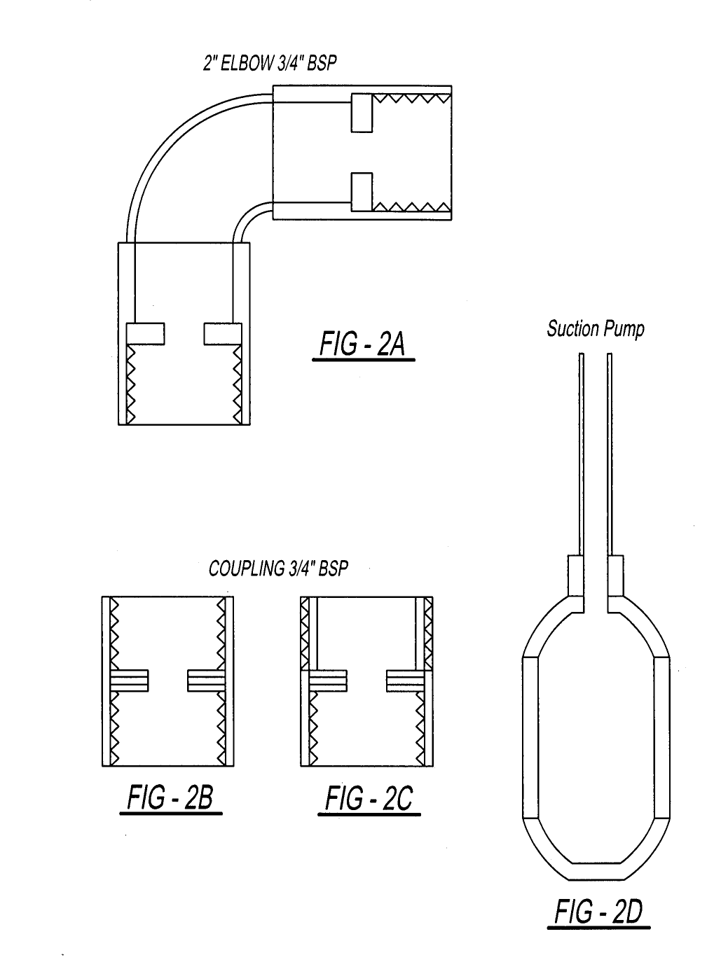

The said cylindrical protruded passageway provided on the top proximal surface of the filtering device enables the flow of the impure water from the upstream into the said device. The said cylindrical passageway may either be directly connected to the water source such as taps or by the hose pipes, couplings and elbows provided with necessary provisions for enabling a sealed contact with the filter in-let as illustrated in FIG. 2. This provision of the said device enables the proper interchange between the impure water and the soap solution prior to the entry into the filtering cartridges or meshes of the said device.

Filter housing has a top proximal end and a bottom distal end wherein the cross-sectional area of proximal end is relatively larger than the cross-sectional area of distal end. Filter housing proximal end can contain threads therein, such as female threads FT shown in FIG. 1, for the mating engagement with upstream water source supplied through pipes and taps. Additionally, filter housing distal end is adapted to be connected with a downstream water supply, such as hose and can include threads thereon, such as male threads MT shown in FIG. 2, or other arrangement for engagement with the downstream water supply into the washing machine or dish washers. The downstream water supply, such as hose, can then supply a downstream device (e.g., washing machine) with filtered water. Filter housing can further include a plurality of external ribs which extend radially outward from proximal end. External ribs can assist the user in gripping filter housing during the installation engagement with impure water source when forming the assembled unit. It is additionally understood that filter housing may also include a plurality of external ribs (not shown) for a similar purpose.

The multiple level water pre-filter device removably attached to the in-let of the washing machine and dish washer as illustrated in FIG. 1 wherein the said two projections at the top proximal surface are cylindrical and conical enabling easy connection with the upstream water flow and for the ease of addition of powder and solution to the said upstream water and the said conical projection for the addition of soap solution and washing powder to the in-let up stream water is removably closed by a cap engaged during periods of non-usage. The said projection at the bottom distal end connects the out-let pure and filtered water from the multiple level water filter into the drum of the washing machine and dish washer.

A further embodiment of the apparatus comprises, a tapered cone or a cup acting as a funnel fixed at the side of the apparatus to be used as passage for a undissolved detergent or washing powder to be poured inside the apparatus, where it is mixed with water as shown in FIG. 1. The said arrangement may be fixed at any side of the apparatus, where it is mixed with impure water, before entering the filter. The said arrangement may also be fixed at the top of the purifier or apparatus, prior to the filter arrangement. The said cone or cup shaped funnel has a removable cap at the top meant for closing the cone or cup shaped funnel.

The plurality of multi-layered filtering mesh arrangement is sandwiched between the said top proximal surface and the bottom distal ends. The said plurality of multi-layered filtering mesh comprises at least 6 meshes with the first mesh positioned closer to the top proximal surface with 841 microns in size made of a material suitable for the filtering material resistible to rusting and corrosion. The second mesh is positioned below the said first mesh is of 400 microns in size and the third mesh is positioned below the said second mesh with 177 microns in size. The fourth mesh is positioned below the said third mesh is of 149 microns in size and the fifth mesh is positioned below the said fourth mesh with 125 microns in size and finally the sixth mesh is positioned below the said fifth mesh and closer to the said bottom distal surface with 105 microns in size for systematically filtering out the sediments, dirt and visible, invisible impurities from the upstream water.

The plurality of sandwiched meshes filter out the impurities of all dimensions from the in-let impure water through continuous filtering process executed by the said at least six mesh arrangement. Water filter apparatus further includes multiple inner filter components which are housed within filter housing and which provide the capability to filter the water flowing through the device. A pre-screen filter with at least 6 meshes is provided which essentially consists of an inverted dome-shaped mesh basket and which provides filtering of the largest sediment particles to the smallest particles contained in the water source. For example, pre-screen filter can comprise a stainless steel basket made of wire mesh which provides a 900-100 micron rated filtering capability to filter out sediment particles of 100 micron or larger size.

The graduated filtration enabled by plurality of multi-layered filter through media filter units comprising the mesh arrangement allows for varying sized sediment particles to be filtered in different layers within water filter apparatus such that the filtering life of the device is extended for a longer period of time than that which is provided by prior art screens of only one size. It is understood that media filter units comprising the mesh arrangement can be constructed of any suitable material which can provide the graduated filtering capabilities as described above. Such materials may include felt material (such as polyester non-woven fabric) or sponge material. Additionally, it is understood that the number of graduated filter media unit layers provided can be varied and adjusted according to the specific water characteristics sought to be filtered (e.g., filter units sized of 200 micron, 100 micron, 50 micron, and 25 micron as tested and described below).

The multiple level water pre-filter devices removably attached to the in-let of the washing machine and dish washer as illustrated in FIG. 1 wherein a plurality of multiple narrow separators/stalks of substantial height are diagonally arranged between each of the multiple layered mesh filters providing a space between the said multiple meshes. This stalk arrangement is made of PVC with substantial height suitable enough to provide free flow of water between each of the sandwiched meshes and for collecting the impurities between these meshes. The entire device along with the top proximal end, bottom distal end and the meshes are encapsulated in 80 mm outer diameter suitable enough for the device to compactly get connected to the house hold machines.

The said filtering device is further provided with a vacuum pressure pump operated individually from the said device enabling the removal of the clogged impurities from the top proximal surface though the cylindrical or conical passageways provided without the removal of the said device from the installation. The pump as illustrated in FIG. 2 is made of an expandable rubber bulb at the top connected to a PVC slender pipe for suctioning the clogs from the filter through the application of manual air pressure. Further the multiple level water pre-filter devices removably attached to the in-let of the washing machine and dish washer device is connectable upside down for reverse/back washing the filters and the meshes free of the sediments and dirt collected by the device due to the filtering process out from the device.

A method of purifying and filtering the sediments, dirt, visible and invisible impurities from the upstream water prior to the in-let of the washing machine and dish washer comprises the steps of in-letting the impure water from the upstream containing the sediments, dirt, visible and in visible impurities through the said cylindrical projection provided in the top proximal surface of the said filtering apparatus prior to the in-let into the washing machine and dish washer, manually in-letting the detergent through the said conical projection provided adjacent to the said cylindrical projection in the said top proximal surface for mixing with the water from the upstream prior to the entering of the underlying mesh in the filtering device, providing a space prior to the multi-layer filtering mesh for the mixing of the said upstream water and the said detergent, soap powder and solution, allowing the flow of the detergent mixed unfiltered water with impurities through the said multi-layered mesh filtering means positioned below the said top proximal surface separated by the vertical stalk, repeated filtering the detergent mixed water by the said at least six levels of mesh filtering means and out-letting the purified water void of sediments, dirt and visible, invisible impurities through the out-let port for domestic usage by the washing machine and dish washer.

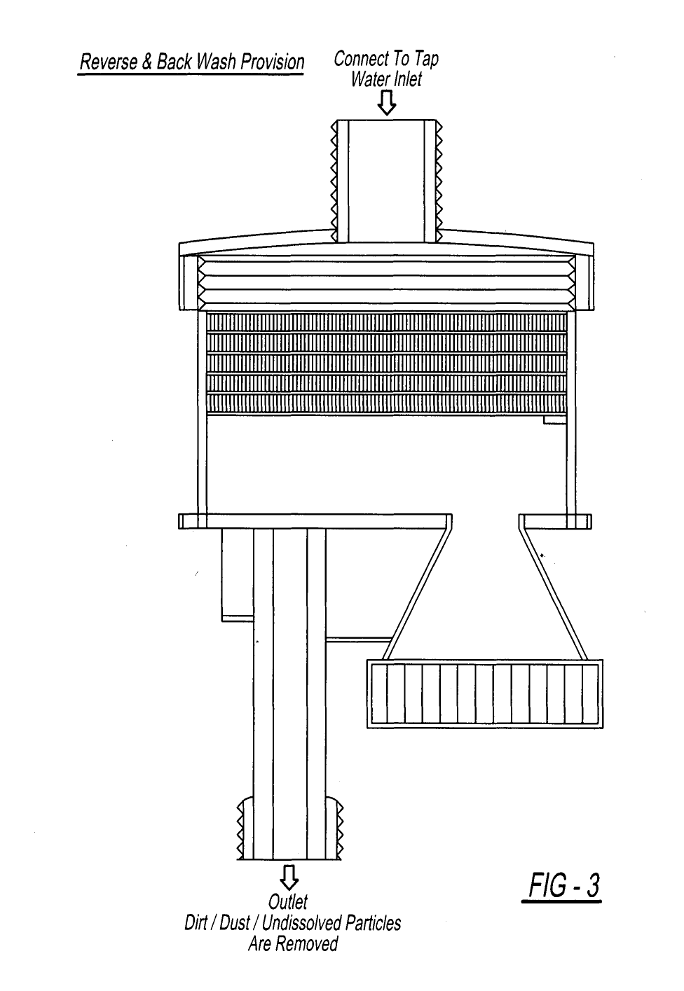

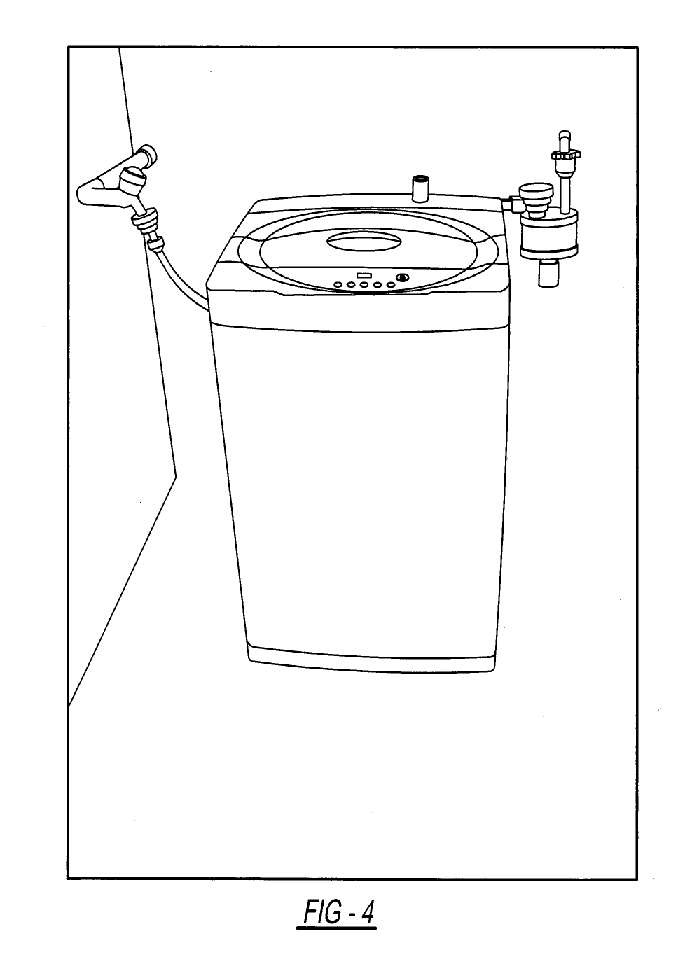

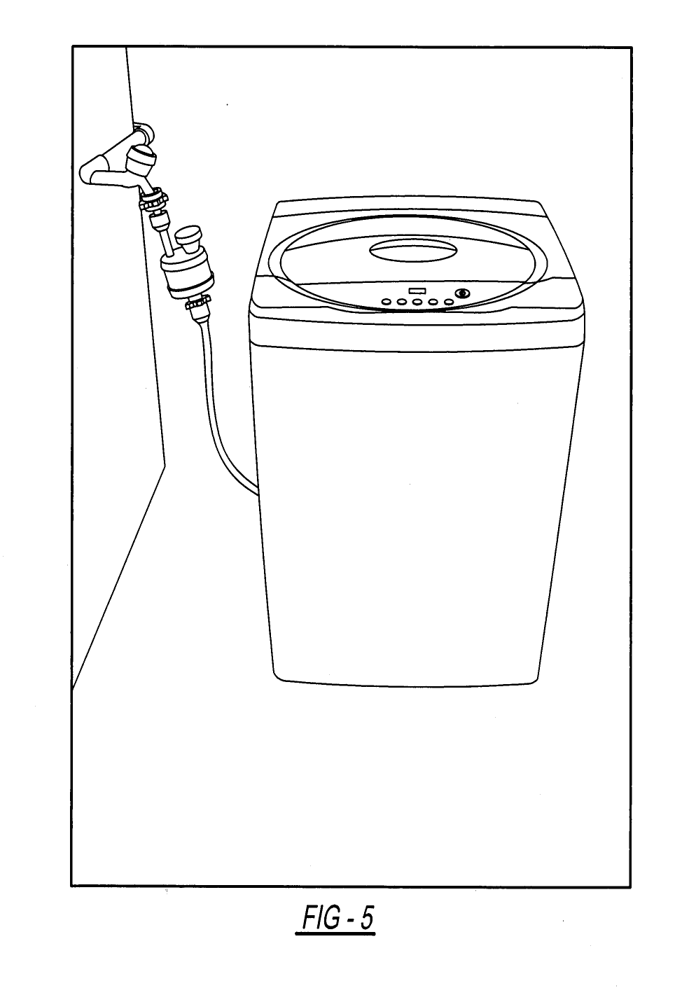

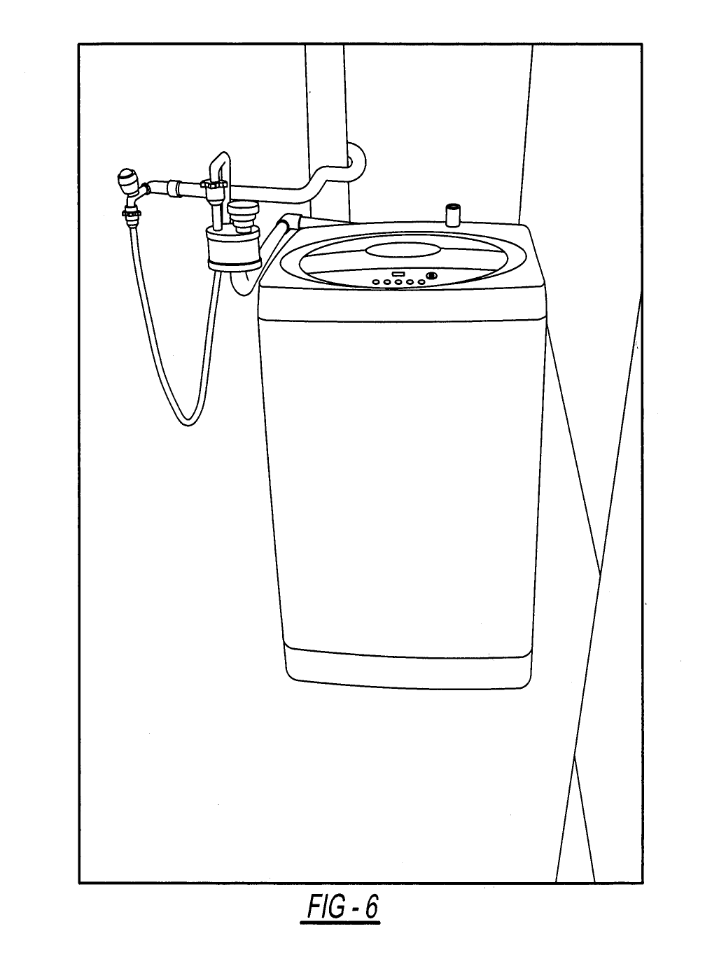

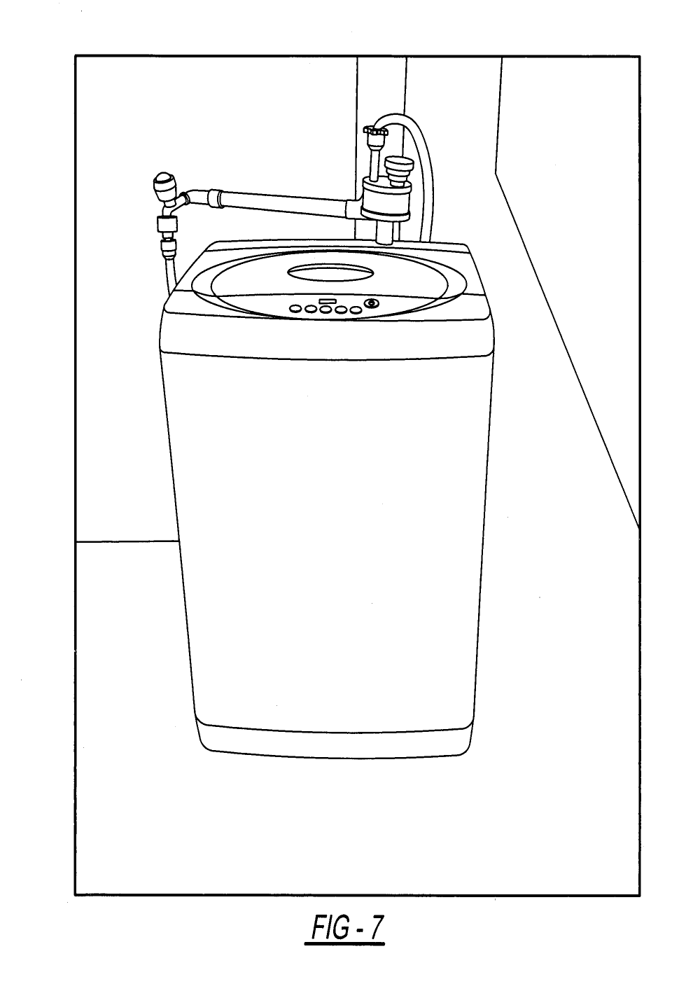

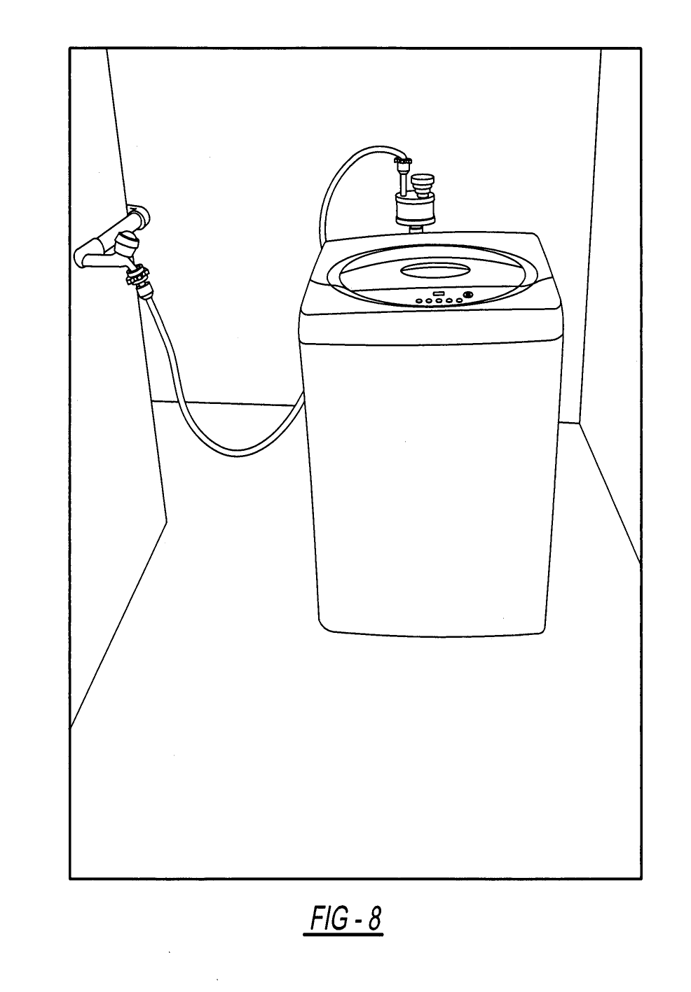

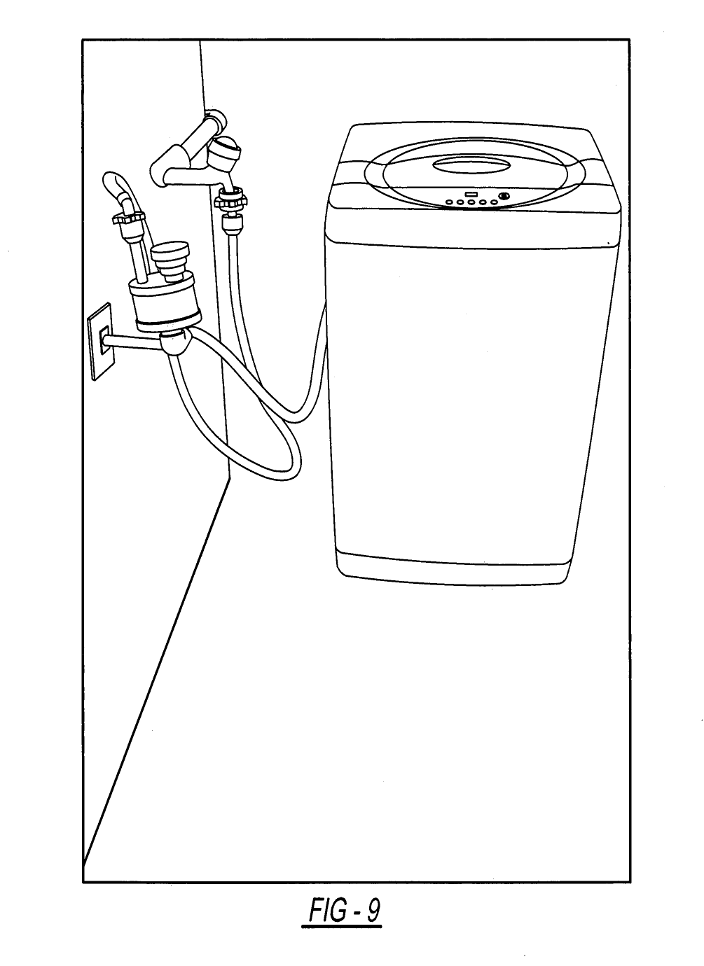

Further the method for reverse or back washing the said device for the removal of the trapped sediments, dirt and visible, invisible impurities from the said device as illustrated in FIG. 3 comprises the steps of reverse washing the said device wherein the in-let and out-let ports are reversed for the removal of the filtered impurities, connecting the said water, purifier assembly to the upstream water in a reverse position as the bottom distal side in the upwards position and top proximal side in the downwards position, free flowing the trapped impurities under the pressure of the water used for cleaning the device, injecting fresh water through the out-let port for removing the impurities out of the device leaving the said device free of the trapped impurities and restoring the said device to the original position for reinstating the top proximal surface and down distal surface to its original position for executing the normal performance of cleaning.

### Protection to the Machine

The undissolved particles in the detergent, soap solution which act as a threat to the washing purpose are being filtered by the multiple-layered mesh filtering device. The presence of the coarse soap detergents results in white patches in the washed clothes providing damages to the cloth fabric. Further the undissolved soap powder and detergent occurring in the drum of the washing machine damages the shaft, bearings and oil seals during the long run operation of the washing machine. The filtering of the coarse soap detergents from the in-let of the washing machine gradually increases the life time and operating efficiency of the washing machine. The maintenance cost to maintain the washing machine in good condition is thus reduced to a large extant and the white patches occurring in the washed clothes is eliminated completely by the filtering of the impure water mixed with the soap detergent prior to the entry into the washing machine in-let.

### Fitment in the Pre-Determined Location

The filtering device of the present invention is suitable to be placed on the top or front of the washing machine at instances where the washing machine is fixed at space cramped locations from the upstream water source. The provision is provided for extending the hose pipes from the water upstream to either the top or front position of the washing machine suitable enough for the attachment of the said filtering device of the present invention. The present filtering device is handy in fixing either near to the water source or at a location away from the upstream impure water source prior to the in-let into the washing machine. The said entire arrangement is being placed before the water enters into the washing machine and for allowing the purified water to enter the machine to render it free from damages. Although the present invention has been described with respect to a specific embodiment and application, it is not limited thereto. Numerous variations and modifications readily will be appreciated by those skilled in the art. One example is a reversal of flow in the filter. These and other examples are all intended to be included within the scope of the present invention, which is recited in the following claims.

I claim:

1) A multiple level water pre-filter device removably attached to the in-let of the washing machine and dish washer comprises
(1) A proximal top surface comprising at least two protruding projections for the in-let of the water from the upstream and the washing powder and solutions.
(2) A distal bottom surface comprising at least one protruding projection for the out-let of the multi-level filtered water mixed with the said powder and soap solutions.
(3) Multi-layered filtering material sandwiched between the said top proximal surface and the bottom distal surface.
(4) A plurality of narrow separator stalks interlaced between each of the said multi-layered filtering material for providing a space for the flow of filtered water between each of the said material.

2) The multiple level water pre-filter device removably attached to the in-let of the washing machine and dish washer as claimed in claim 1 wherein the said two projections at the top proximal surface are cylindrical and conical enabling easy connection with the upstream water flow and for the ease of addition of powder and solution to the said upstream water.

3) The multiple level water pre-filter device removably attached to the in-let of the washing machine and dish washer as claimed in claim 2 wherein the said conical projection for the addition of soap solution and washing powder to the in-let up stream water is removably closed by a cap.

4) The multiple level water pre-filter device removably attached to the in-let of the washing machine and dish washer as claimed in claim 1 wherein the said projection at the bottom distal end connects the out-let filtered water from the multiple level water filter into the drum of the washing machine and dish washer.

5) The multiple level water pre-filter devices removably attached to the in-let of the washing machine and dish washer as claimed in claim 1 wherein the said multi-layered filtering material comprises meshes of different dimensions.

6) The multiple level water pre-filter devices removably attached to the in-let of the washing machine and dish washer as claimed in claim 5 wherein the said filtering mesh comprises at least 6 meshes with
i) The first mesh closer to the top proximal surface is 841 microns in size with the filtering material resistible to rusting and corrosion.
ii) The second mesh positioned below the said first mesh is 400 microns in size.
iii) The third mesh positioned below the said second mesh is 177 microns in size.
iv) The fourth mesh positioned below the said third mesh is 149 microns in size.
v) The fifth mesh positioned below the said fourth mesh is 125 microns in size and
vi) The sixth mesh positioned below the said fifth mesh and closer to the said bottom distal surface is 105 microns in size for systematically filtering out the sediments, dirt and visible, invisible impurities from the upstream water.

7) The multiple level water pre-filter devices removably attached to the in-let of the washing machine and dish washer as claimed in claim 1 wherein the said multiple narrow separators of substantial height are diagonally arranged providing a space between the said multiple meshes.

8) The multiple level water pre-filter devices removably attached to the in-let of the washing machine and dish washer as claimed in claim 1 wherein the said device is connectable upside down for back washing the filters and the meshes free of the sediments and dirt from the device.

9) A method of purifying and filtering the sediments, dirt, visible and invisible impurities from the upstream water prior to the in-let of the washing machine and dish washer comprises the steps of
i) In-letting the impure water from the upstream containing the sediments, dirt, visible and in visible impurities through the said cylindrical projection provided in the top proximal surface of the said filtering apparatus prior to the in-let into the washing machine and dish washer.
ii) Manually in-letting the detergent through the said conical projection provided adjacent to the said cylindrical projection in the said top proximal surface for mixing with the water from the upstream prior to the entering of the underlying mesh in the filtering device.
iii) Providing a space prior to the multi-layer filtering mesh for the mixing of the said upstream water and the said detergent, soap powder and solution.
iv) Allowing the flow of the detergent mixed unfiltered water with impurities through the said multi-layered mesh filtering means positioned below the said top proximal surface separated by the vertical stalk.
v) Repeated filtering the detergent mixed water by the said at least six levels of mesh filtering means.
vi) Out-letting the purified water void of sediments, dirt and visible, invisible impurities through the out-let port for domestic usage by the washing machine and dish washer.

10) A method for reverse or back washing the said device for the removal of the trapped sediments, dirt and visible, invisible impurities from the said device comprises the steps of
i. Reverse washing the said device wherein the in-let and out-let ports are reversed for the removal of the filtered impurities.
ii. Connecting the said water purifier assembly to the upstream water in a reverse position as the bottom distal side in the upwards position and top proximal side in the downwards position.
iii. Free flowing the trapped impurities under the pressure of the water used for cleaning the device.
iv. Injecting fresh water through the out-let port for removing the impurities out of the device leaving the said device free of the trapped impurities.
v. Restoring the said device to the original position for reinstating the top proximal surface and down distal surface to its original position for executing the normal performance of cleaning.
